(19) United States
(12) Patent Application Publication
(10) Pub. No.: US 2023/0127049 A1
(43) Pub. Date: Apr. 27, 2023

(54) GROMMET UNIT

(71) Applicant: SUMITOMO WIRING SYSTEMS, LTD., Yokkaichi-shi, Mie (JP)

(72) Inventor: Takeo MARUCHI, Yokkaichi-shi (JP)

(73) Assignee: SUMITOMO WIRING SYSTEMS, LTD., Yokkaichi-shi, Mie (JP)

(21) Appl. No.: 17/908,739

(22) PCT Filed: Oct. 23, 2020
(86) PCT No.: PCT/JP2020/039827

§ 371 Date: Sep. 1, 2022

(30) Foreign Application Priority Data
Mar. 9, 2020 (JP) 2020-040251

(51) Int. Cl. F16L 5/02; H01B 17/58

(52) U.S. Cl. CPC F16L 5/02; H01B 17/583

(57) ABSTRACT

A grommet unit to be attached to an attachment surface of an attachment-target body, the grommet unit including: a tubular grommet having a groove on a surface thereof; a bracket to be overlaid onto the grommet and press the grommet against the attachment-target body in a first direction; and a communication passage formed by covering the groove of the grommet with the bracket, wherein the communication passage has a first end that is in communication with a space between overlapping surfaces of the bracket and the attachment surface, and a second end that is in communication with a portion where the grommet and the bracket are not overlaid on each other.

### BACKGROUND

The present disclosure relates to a grommet unit that includes a water-sealing grommet and a bracket for pressing the grommet so as to be attached to an attachment-target body.

Conventionally, a grommet unit that is used when pulling a wire harness routed under the floor of a vehicle into the vehicle is known. The grommet unit includes, as also disclosed in JP 2016-210214A, a grommet made of rubber or the like, and a bracket that is fixed to a vehicle panel serving as an attachment-target body. By fixing the bracket to the vehicle panel, the grommet is mounted in a state of being pressed against the panel, and the portion of the panel through which the wire harness is drawn is sealed by the grommet.

### SUMMARY

However, it is also conceivable that, when water forcefully enters between the bracket and the vehicle panel due to the application of water by a high-pressure cleaning device or the like, high water pressure will be exerted on the seal portion realized by the grommet being pressed against the panel and break the seal realized by the grommet, thus allowing water to further enter. In particular, when, for example, the elasticity of the grommet changes and the sealing performance is reduced due to deterioration over time or the like, it is also conceivable that the grommet will not able to withstand the effect of high water pressure.

An exemplary aspect of the disclosure provides a grommet unit with a novel structure in which a seal realized by a grommet pressing against an attachment-target body such as a panel is effectively maintained, even if water forcefully enters between a bracket and the attachment-target body.

A grommet unit according to the present disclosure is a grommet unit to be attached to an attachment surface of an attachment-target body, the grommet unit including: a tubular grommet having a groove on a surface thereof, a bracket to be overlaid onto the grommet and press the grommet against the attachment-target body in a first direction; and a communication passage formed by covering the groove of the grommet with the bracket, wherein the communication passage has a first end that is in communication with a space between overlapping surfaces of the bracket and the attachment surface, and a second end that is in communication with a portion where the grommet and the bracket are not overlaid on each other.

According to the present disclosure, even if water forcefully enters between the bracket and the attachment-target body, a seal realized by the grommet pressing against the attachment-target body is effectively maintained.

### BRIEF DESCRIPTION OF THE DRAWINGS

FIG. 1 is a perspective view of a grommet unit according to Embodiment 1.

FIG. 2 is a front view of the grommet unit shown in FIG. 1.

FIG. 3 is an exploded perspective view of the grommet unit shown in FIG. 1.

FIG. 4 is an exploded perspective view of the grommet unit shown in FIG. 1, as seen from another angle.

FIG. 5 is a cross-sectional view taken along line V-V in FIG. 2.

FIG. 6 is a perspective view of a grommet unit according to Embodiment 2.

FIG. 7 is a front view of the grommet unit shown in FIG. 6.

FIG. 8 is an exploded perspective view of the grommet unit shown in FIG. 6.

### DETAILED DESCRIPTION OF EMBODIMENTS

### Description of Embodiments of Present Disclosure

First, embodiments of the present disclosure will be listed and described below.

A grommet unit of the present disclosure is

(1) a grommet unit to be attached to an attachment surface of an attachment-target body, the grommet unit including: a tubular grommet having a groove on a surface thereof, a bracket to be overlaid onto the grommet and press the grommet against the attachment-target body in a first direction; and a communication passage formed by covering the groove of the grommet with the bracket, wherein the communication passage has a first end portion that is in communication with a space between overlapping surfaces of the bracket and the attachment surface, and a second end portion that is in communication with a portion where the grommet and the bracket are not overlaid on each other.

With the grommet unit of the present disclosure, water that has entered between overlapping surfaces of the bracket and the attachment surface is drained from the first end portion to the second end portion of the communication passage. Thus, even if water forcefully enters between overlapping surfaces of the bracket and the attachment surface, the water pressure exerted on the seal portion of the grommet pressed against the attachment-target body can be reduced, and the water can be prevented from moving to the inner circumference of the grommet and entering the vehicle interior or the like.

(2) It is preferable that the groove is provided at a plurality of positions in a circumferential direction of the grommet. As a result of a plurality of communication passages being formed by the plurality of grooves, the total flow rate of the communication passages can be increased, the water pressure exerted on the seal portion of the grommet can be further reduced due to an improvement in drainage performance realized by the communication passages, and the water-sealing performance can be increased.

(3) It is preferable that the bracket includes an insertion hole into which the grommet is to be inserted, and a fixing portion to be fixed to the attachment-target body, the fixing portion is provided at a plurality of positions to be spaced apart from each other in a second direction extending in a circumferential direction of the insertion hole, and the first end portion of the communication passage is provided between the fixing portions in the second direction.

A gap is likely to form between a portion of the bracket separated from the fixing portion in the second direction, which is the circumferential direction, and the attachment-target body, and there are cases where water can more easily enter a space between the bracket and the attachment-target body than at a portion near the fixing portion. Thus, if the first end portion of the communication passage is disposed at a position separated from the fixing portion, water that has entered a space between the bracket and the attachment-target body at a position separated from the fixing portion can be swiftly guided to the communication passage and drained from the communication passage, and water pressure exerted on the seal portion of the grommet can be efficiently reduced. Note that, if more than one communication passage is provided, provided that the first end portion of at least one communication passage is located at a position separated from the fixing portion, the aforementioned effects can be obtained.

(4) It is preferable that the grommet has a first surface onto which the bracket is to be overlaid in the first direction, and the groove includes a liquid pressure exertion portion that is open to the first surface. The pressure of water flowing through a portion of the communication passage constituted by the liquid pressure exertion portion is exerted on the grommet in the first direction, and thus the grommet is pressed toward the attachment-target body side by the water pressure. Therefore, when water enters between the bracket and the attachment-target body, the liquid-tightness (water sealing) between the grommet and the attachment-target body is improved.

(5) In (4) above, it is preferable that the grommet includes an annular mounting portion to be located between opposing surfaces of the bracket and the attachment-target body, the annular mounting portion has the first surface, and the annular mounting portion includes an annular sealing lip that protrudes toward the attachment-target body, on the side opposite to the first surface.

Because the first surface and the sealing lip are each provided on one side of the annular mounting portion in the first direction, the pressure of water flowing through the liquid pressure exertion portion and acting on the annular mounting portion in the first direction is more directly transferred to the sealing lip. Thus, the sealing lip is efficiently pressed against the attachment-target body and the liquid-tightness between the grommet and the attachment-target body realized by the sealing lip being pressed against the attachment-target body is effectively ensured.

(6) In (5) above, it is preferable that an outer circumferential surface of the sealing lip is located at the same position as a groove bottom surface of the groove at the first end portion, in a radial direction of the grommet. By providing the sealing lip on the outer circumferential portion of the annular mounting portion of the grommet, the pressure of water that has entered between the grommet and the attachment-target body from the outer circumferential side of the sealing lip can be used to suppress a force acting in a direction opposite to the first direction in which the grommet would separate from the attachment-target body from being exerted on the grommet. Thus, the sealing performance realized by the sealing lip being pressed against the attachment-target body is effectively exhibited without being reduced by water pressure exerted on the grommet.

(7) It is preferable that a first area that is the area of a portion of the surface of the grommet that is not in contact with the bracket due to the groove is larger than a second area that is the area of a portion of the surface of the grommet that that is in contact with the bracket. Accordingly, a large cross-sectional area is secured for the communication passages, and the draining performance realized by the communication passages is improved, and thus the liquid-tightness between the grommet and the attachment-target body is ensured. Note that providing a plurality of grooves ensures a large total cross-sectional area of the communication passages, and thus the sealing performance is improved in response to an improvement in the drainage performance.

(8) It is preferable that the bracket has an annular shape, the grommet has a protruding portion that protrudes further than the bracket in a third direction that is the opposite of the first direction, when the grommet is inserted into the bracket, the groove extends to the protruding portion of the grommet, further than the bracket, the grommet includes a locking portion that locks onto an end surface of the bracket in the third direction, and restricts movement of the grommet in the first direction relative to the bracket, and the locking portion is provided at a portion distanced from the groove in the circumferential direction.

The groove extends to the protruding portion, and thus water drained from the second end portion of the communication passage is drained toward the outer circumference at an end portion of the grommet in the third direction. As a result of the locking portion of the grommet being locked onto the bracket, movement of the protruding portion of the grommet in the first direction relative to the bracket is restricted, and the protruding portion is stably held protruding in the third direction from the insertion hole of the bracket. By providing the locking portion in a portion separated from the groove in the circumferential direction of the grommet, the groove can extend to the protruding portion.

### Detailed Description of Embodiment of the Present Disclosure

Specific examples of a grommet unit of the present disclosure will be described below with reference to the drawings. Note that the present disclosure is not limited to these illustrative examples, but is indicated by the claims, and all changes that come within the meaning and range of equivalency of the claims are intended to be embraced therein.

### Embodiment 1

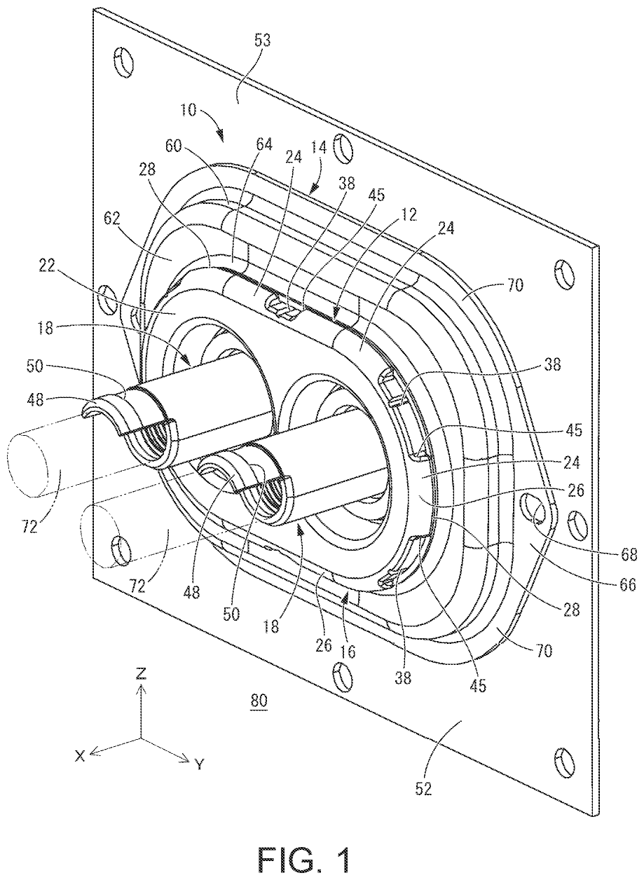

Embodiment 1 of the present disclosure will be described below with reference to FIGS. 1 to 5. A grommet unit 10 according to Embodiment 1 includes a grommet 12 and a bracket 14 for attaching the grommet 12 to a panel 52 serving as an attachment-target body (described below). In the following description, the upward direction refers to the Z direction in FIG. 1, the forward direction refers to the X direction in FIG. 1, and the rightward direction refers to the Y direction in FIG. 1. Also, in the following description, the first direction refers to the rearward direction, which is the opposite direction to the X direction, and the third direction refers to the forward direction, which is the X direction. Note that, the upward direction, the forward direction, and the rightward direction mentioned here do not necessarily correspond to the upward direction, the forward direction, and the rightward direction of a vehicle to which the grommet unit 10 is attached. Also, reference numerals may be given only to some members of a plurality of identical members and reference numerals may be omitted for the other members.

### <Grommet 12>

The grommet 12 is a member that exhibits rubber-like elasticity, and is made of rubber or a resin elastomer, for example. As shown in FIGS. 1 to 5, the grommet 12 includes a base portion 16 that is overlaid onto the later-described vehicle panel 52, and tubular portions 18 that protrude forward from the base portion 16.

### <Base Portion 16>

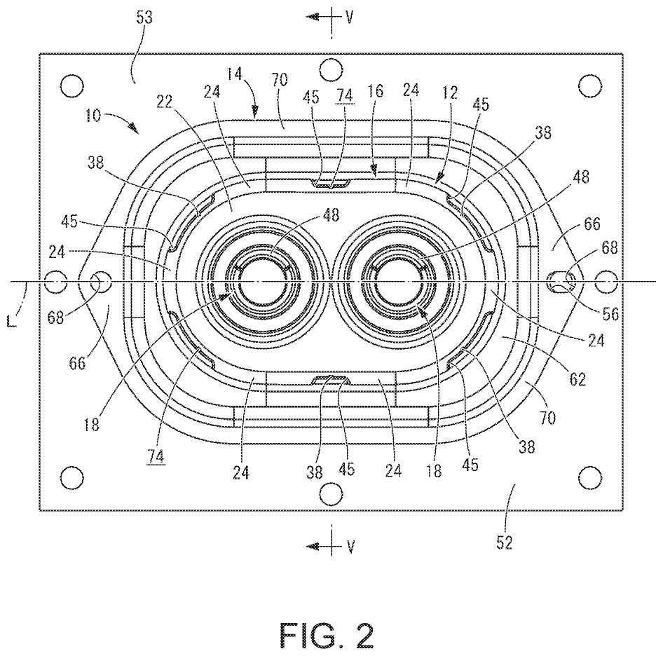

As seen in the front view shown in FIG. 2, the outer circumference of the base portion 16 has a substantially oval shape that includes straight portions. The base portion 16 includes two electric wire insertion holes 20 that extend therethrough in the front-rear direction, the two electric wire insertion holes 20 being arranged in the longitudinal direction of the base portion 16.

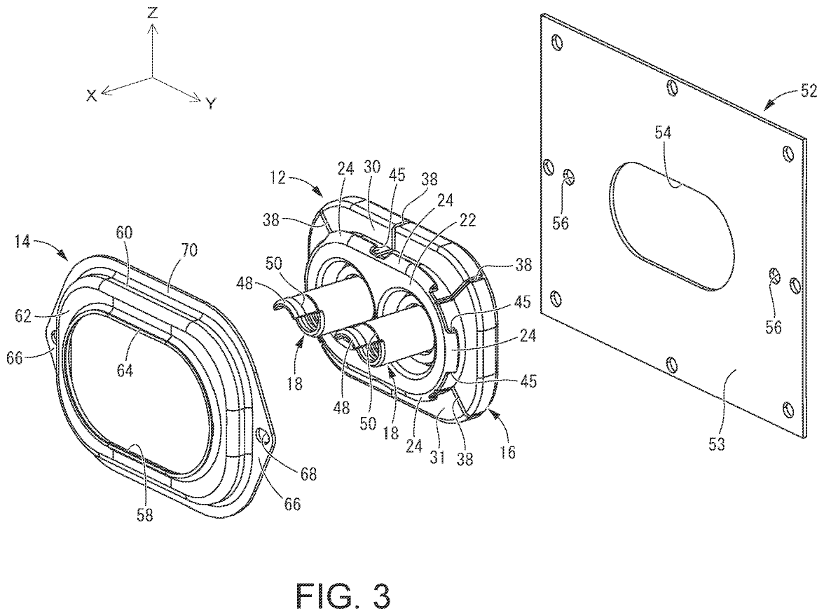

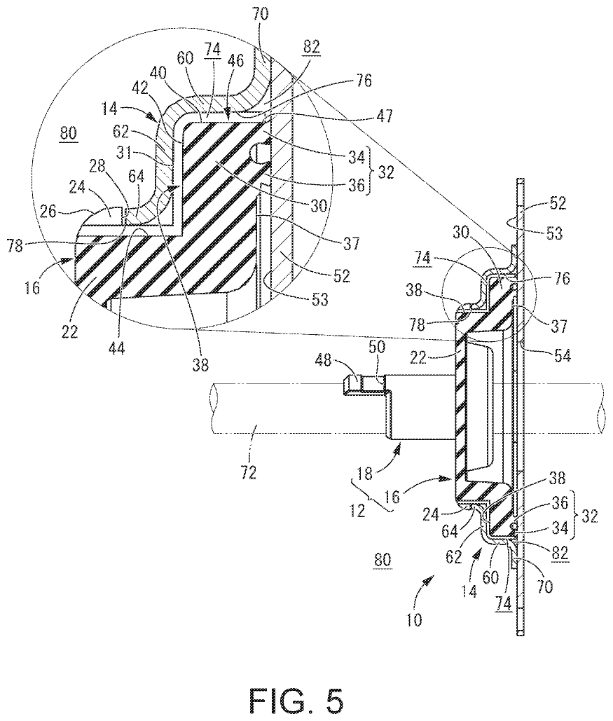

As shown in FIG. 3, the rear portion of the base portion 16 is larger in diameter than the front portion, the front portion being a protruding portion 22 (protrusion). The protruding portion 22 includes locking portions 24 (locks) that protrude toward the outer circumference of the base portion 16. As shown in FIG. 5, the end surface on the front side of each locking portion 24 is an inclined guiding surface 26 that is inclined inward in a radial direction toward the front. The end surface on the rear side of each locking portion 24 is a flat locking surface 28 that extends substantially orthogonal to the front-rear direction. The locking portions 24 are separated forward from and oppose a later-described annular mounting portion 30 (annular mount).

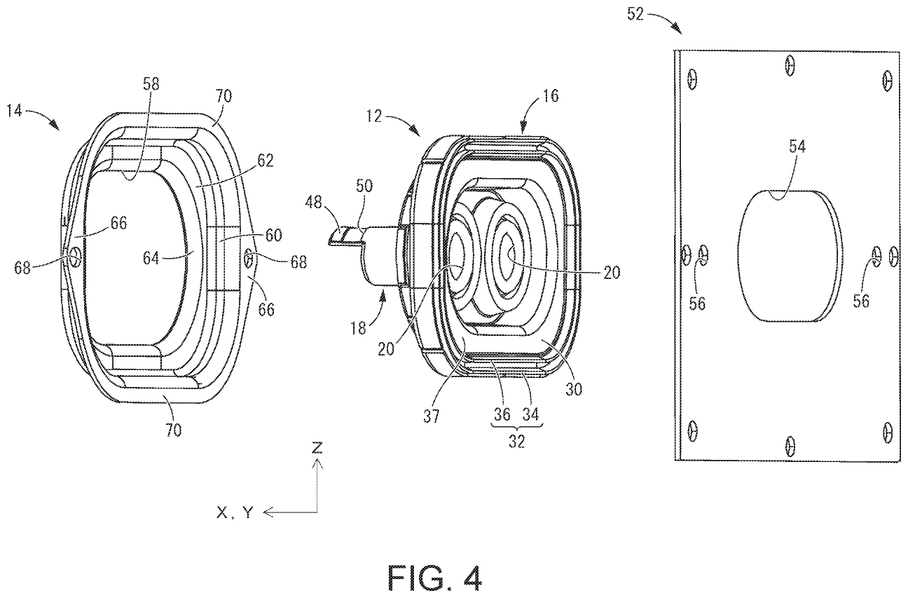

As shown in FIG. 3, the rear portion of the base portion 16 includes the annular mounting portion 30 that protrudes toward the outer circumference of the grommet 12 more than the protruding portion 22. The front surface of the annular mounting portion 30 is a flat first surface 31 that extends substantially orthogonal to the front-rear direction. As shown in FIGS. 4 and 5, the annular mounting portion 30 is provided with a sealing lip 32 that protrudes rearward. The sealing lip 32 has a double-layered structure including an outer circumferential lip 34 and an inner circumferential lip 36. The outer circumferential lip 34 and the inner circumferential lip 36 each have an annular shape that is continuous over the entire circumferential direction of the base portion 16, the outer circumferential lip 34 has a larger diameter than the inner circumferential lip 36, and the outer circumferential lip 34 extends on the outer circumferential side of the inner circumferential lip 36 at a position separated therefrom. The outer circumferential lip 34 and the inner circumferential lip 36 both have a tapered cross-sectional shape in which the width thereof decreases toward the leading end. The outer circumferential lip 34 and the inner circumferential lip 36 protrude from a second surface 37 that is located on a side of the annular mounting portion 30 opposite to the first surface 31, and are located at radial positions that overlap the first surface 31 in the front-rear direction.

### <Groove 38>

As shown in FIG. 5, a groove 38 is formed in the base portion 16 of the grommet 12. The groove 38 includes a groove base end portion 40 that is open to the outer circumferential surface of the annular mounting portion 30, a liquid pressure exertion portion 42 that is open to the first surface 31, which is the front surface of the annular mounting portion 30, and a groove leading end portion 44 that is open to the outer circumferential surface of the front portion of the base portion 16 distanced from the annular mounting portion 30, the groove base end portion 40, the liquid pressure exertion portion 42, and the groove leading end portion 44 being continuous with each other. The groove 38 extends in the front-rear direction at the groove base end portion 40 and the groove leading end portion 44, and extends in the radial direction of the grommet 12 at the liquid pressure exertion portion 42. The groove 38 extends continuously from the rear end of the base portion 16 to the front end of the base portion 16, and the groove leading end portion 44 extends to the protruding portion 22. Preferably, the groove 38 is provided at a plurality of positions of the base portion 16, and in the present embodiment, six grooves 38 are arranged spaced apart from each other in the circumferential direction of the base portion 16. The cross-sectional shape of the grooves 38 is not particularly limited, and the cross-section has a semi-circular shape in the present embodiment.

The groove leading end portion 44 of the groove 38 is open to the outer circumferential surface of the protruding portion 22, at a groove opening portion 45 where the locking portion 24 is not partially formed. In other words, the locking portion 24 is provided distanced in the circumferential direction from the groove opening portion 45 where the groove leading end portion 44 of the groove 38 is formed. The width of the groove opening portion 45 is larger than the width of the groove 38, and the groove 38 is open in a width direction portion of the groove opening portion 45.

In the present embodiment, a groove bottom surface 46 of the groove 38 at the rear end of the groove base end portion 40 is located at substantially the same radial position as a lip outer surface 47, which is the outer circumferential surface of the outer circumferential lip 34, and the groove bottom surface 46 and the lip outer surface 47 are smoothly continuous with each other. The groove 38 of the present embodiment has a substantially semi-circular cross section, and thus the groove bottom surface 46 of the groove 38 is located at substantially the same radial position as the lip outer surface 47 at a portion where the groove 38 is deepest. In this way, the groove bottom surface 46 and the lip outer surface 47 may be at least partially located at substantially the same radial position. Note that the groove bottom surface 46 of the groove 38 being located at substantially the same radial position as the lip outer surface 47 includes cases where they can be considered as being substantially located at the same position even if they are continuous with a step or incline of a certain magnitude. Specifically, provided that positional deviation in the radial direction between the groove bottom surface 46 of the groove 38 and the lip outer surface 47 is within 1 mm, the two can be deemed as being disposed at substantially the same position.

### <Tubular Portion 18>

As shown in FIGS. 3 and 4, tubular portions 18 protrude toward the front side forward from the opening edge portions of the electric wire insertion holes 20 in the base portion 16. In the present embodiment, two tubular portions 18 are arranged in the left-right direction, which is the longitudinal direction of the base portion 16. Fastening pieces 48 are formed as one piece with the leading ends of the tubular portions 18, respectively. Each fastening piece 48 has an arc-shaped cross section that extends in the circumferential direction, and protrudes forward from the leading end of the tubular portion 18. A positioning groove 50 that extends in the circumferential direction is formed to be open to the outer circumferential surface of each fastening piece 48. The base portion 16 has a shape in which the opening edge portions of the electric wire insertion holes 20 connected to the tubular portions 18 are thin and have play in the thickness direction, which allows relative orientation and position changes of the tubular portions 18 relative to the base portion 16 while mitigating the transmission of vibration from the tubular portions 18 to the base portion 16.

### <Panel 52>

The grommet 12 is overlaid onto the vehicle panel 52. The panel 52 is a member that constitutes the body or chassis of a vehicle and partitions the inner and outer side of the vehicle interior, and is constituted by a metal plate or the like, for example. The surface on the vehicle interior outer side of the panel 52 is an attachment surface 53 to which the grommet unit 10 is attached. The panel 52 includes a through hole 54 extending therethrough in the thickness direction thereof. The through hole 54 has an oval shape that corresponds to the grommet 12 as seen in a front view, and has a smaller diameter than the annular mounting portion 30 so that the annular mounting portion 30 of the grommet 12 overlaps the opening edge portion of the through hole 54. The panel 52 includes a plurality of bolt holes 56 that extend therethrough in the thickness direction thereof, on the outer circumferential side of the through hole 54.

### <Bracket 14>

The base portion 16 of the grommet 12 is overlaid onto the bracket 14. The bracket 14 is made of metal or the like, and has a substantially oval annular plate shape that corresponds to the entire grommet 12. The bracket 14 has an insertion hole 58 extending therethrough in the front-rear direction. The bracket 14 includes, as one piece, a base end wall portion 60 that is stacked onto the outer circumferential surface of the annular mounting portion 30 of the grommet 12, an intermediate wall portion 62 that extends out from the front end of the base end wall portion 60 toward the inner circumference of the bracket 14, and a leading end wall portion 64 that extends out forward from the inner circumferential end portion of the intermediate wall portion 62.

The rear end of the base end wall portion 60 of the bracket 14 is provided with fixing portions 66. The fixing portions 66 are plate shaped, and are preferably provided at a plurality of positions spaced apart from each other in a second direction extending in the circumferential direction of the insertion hole 58. In the present embodiment, the pair of fixing portions 66 are provided protruding outward from the base end wall portion 60, in a radial direction of the insertion hole 58. Each fixing portion 66 is provided with a bolt hole 68 extending therethrough in the front-rear direction, which is the plate thickness direction thereof. Also, the rear end of the base end wall portion 60 is integrally provided with a reinforcing rib 70 protruding toward the outer circumference of the bracket 14. The reinforcing ribs 70 provided between the pair of fixing portions 66 in the second direction, and continuous with the pair of fixing portions 66 in the second direction. Note that the bracket 14 is a pressed metal fitting, and has an overall structure in which the fixing portions 66 and the reinforcing rib 70 are formed in one piece.

### <Mounting of Grommet Unit 10 to Panel 52>

In a state where the grommet 12 is overlaid on the opening edge portion of the through hole 54 of the panel 52, as shown in FIG. 5, the intermediate wall portion 62 of the bracket 14 is overlaid on the first surface 31 of the annular mounting portion 30 of the grommet 12 in the first direction. Then, the bracket 14 is fixed to the panel 52 by bolts (not shown) inserted into the bolt holes 68 of the fixing portions 66 and the bolt holes 56 of the panel 52 in a state where the fixing portions 66 are overlaid on the panel 52 in the first direction. Accordingly, the grommet unit 10 including the grommet 12 and the bracket 14 is constituted when mounted to the panel 52.

The protruding portion 22 of the base portion 16 of the grommet 12 is inserted into the insertion hole 58 of the bracket 14 so as to protrude further forward than the front end of the bracket 14. The locking portions 24 provided on the protruding portion 22 are overlaid onto the front end surface of the bracket 14 from the front side, and the locking between the flat locking surfaces 28 of the locking portions 24 and the bracket 14 prevents the protruding portion 22 from coming loose rearward of the bracket 14.

When inserting the protruding portion 22 of the grommet 12 into the insertion hole 58 of the bracket 14 from the rear side, the inclined guiding surfaces 26 constituting the front surfaces of the locking portions 24 abut against the bracket 14. Accordingly, the protruding portion 22 is guided to an appropriate position with respect to the bracket 14, and insertion of the protruding portion 22 into the insertion hole 58 of the bracket 14 is facilitated. Also, when inserting the grommet 12 into the insertion hole 58 of the bracket 14 from the rear side, the locking portions 24 are unlikely to catch on the bracket 14, and the grommet 12 can be easily inserted into the insertion hole 58 of the bracket 14.

The annular mounting portion 30 of the grommet 12 is sandwiched in the front-rear direction between opposing surfaces of the intermediate wall portion 62 of the bracket 14 and the panel 52, and the sealing lip 32 protruding from the annular mounting portion 30 toward the panel 52 is pressed against the panel 52 in the first direction. The grommet 12 is positioned relative to the through hole 54 of the panel 52, and the annular mounting portion 30 of the grommet 12 is overlaid on the opening edge portion of the through hole 54 in the panel 52. The through hole 54 is in communication with the inner holes of the electric wire insertion holes 20 and the tubular portions 18 of the base portion 16 of the grommet 12. The sealing lip 32 is pressed against the panel 52 continuously over the entire circumference thereof, around the through hole 54.

### <Electric Wire 72>

Electric wires 72 are passed through the through hole 54 in the panel 52. Each electric wire 72 is an insulated electric wire provided with an insulating coating made of a synthetic resin or the like on the outer side of a core wire constituted by a single wire or twisted strands made of a conductive material. The core wire and the insulating coating of the electric wires 72 are made of well-known common materials. The electric wires 72 are passed through the through hole 54 and respectively passed through the inner holes of the electric wire insertion holes 20 and the tubular portions 18 in the base portion 16, which are in communication with the through hole 54. The outer circumferential surfaces of the electric wires 72 are pressed against the inner circumferential surface of the corresponding tubular portion 18, and the space between surfaces of the electric wires 72 and the tubular portions 18 that overlap each other is sealed to be liquid tight.

The tubular portions 18 through which the electric wires 72 are passed may be fixed to the electric wires 72 as a result of being fastened by wrapping an un-shown band or the like around the fastening pieces 48. Accordingly, the electric wires 72 and the grommet 12 are positioned relative to each other in the length direction of the electric wires 72, and the sealing performance between the electric wires 72 and the tubular portions 18 is improved. Note that, by wrapping a band or the like around the bottom surface of the positioning grooves 50 of the fastening pieces 48, the band or the like is unlikely to come loose from the fastening pieces 48.

### <Seal Structure>

While the grommet 12 is mounted to the panel 52, the annular mounting portion 30 is sandwiched between the panel 52 and the intermediate wall portion 62 of the bracket 14, and the sealing lip 32 protruding rearward from the annular mounting portion 30 is pressed against the panel 52. Accordingly, the space between the overlapping surfaces of the grommet 12 and the panel 52 is sealed by the sealing lip 32 to be liquid tight.

### <Communication Passage 74>

By mounting the base portion 16 of the grommet 12 to the bracket 14, the openings of the grooves 38 formed in the base portion 16 of the grommet 12 are covered by the bracket 14. Accordingly, communication passages 74 formed using the grooves 38 are provided between the overlapping surfaces of the base portion 16 of the grommet 12 and the bracket 14. A first end portion 76, which is one end portion of the communication passages 74, is in communication with opposing surfaces of the attachment surface 53 of the panel 52 and the bracket 14 that oppose each other in the front-rear direction, at the rear surface of the grommet 12 which is on the side where the grommet 12 is mounted to the panel 52. A second end portion 78, which is the other end portion of the communication passage 74, is located at the front end of the bracket 14, and is open to an external space 80 that is located on the forward side of the bracket 14 and is where the bracket 14 is not overlapped. Note that the portion where the bracket 14 is overlaid onto the grommet 12 does not only refer to the portion where the bracket 14 is overlaid onto the grommet 12 in contact therewith, but also includes a portion where the bracket 14 is overlaid so as to oppose the grommet 12 with a gap therebetween. Accordingly, a portion where the bracket 14 is not overlaid onto the grommet 12 refers to a portion where the grommet 12 is separated from the bracket 14 and does not oppose the bracket 14. In the present embodiment, the second end portion 78 of the communication passages 74 is open toward an end portion of the grooves 38 that extends further forward than the bracket 14.

The first end portion 76 is open toward the panel 52 side, and the second end portion 78 is open toward the side opposite to the panel 52. In other words, the first end portion 76 is open rearward, which is the first direction, and the second end portion 78 is open forward, which is the third direction. The first end portion 76 is in communication with a flooding region 82, and the second end portion 78 is in communication with the external space 80. The flooding region 82 is a space defined by opposing surfaces between the base end wall portion 60 and the reinforcing rib 70 of the bracket 14 and the attachment surface 53 of the panel 52, these surfaces opposing each other in the front-rear direction, and is a region into which water that has passed between the overlapping surfaces between the bracket 14 and the panel 52 can enter. The external space 80 is a region separated from the internal space between the bracket 14 and the panel 52, and does not include the flooding region 82, which is a portion of the internal space.

By providing a plurality of the grooves 38 spaced apart from each other in the circumferential direction of the grommet 12, a plurality of communication passages 74 are provided in the circumferential direction of the grommet unit 10. In the present embodiment, six communication passages 74 are arranged at positions spaced apart from each other in the circumferential direction. As shown in FIG. 2, it is preferable that at least one communication passage 74 is provided above a virtual straight line L that joins the bolt holes 68 of the bracket 14, at a position in the circumferential direction of the bracket 14. More preferably, communication passages 74 are located on both sides of the straight line L.

As shown in FIG. 5, the first end portion 76 of the communication passage 74 is open to the flooding region 82, and is located on the outer circumferential side of the outer circumferential lip 34 of the sealing lip 32 that is located on the inner circumference of the flooding region 82. In the present embodiment, the groove bottom surface 46 of the groove 38 at the first end portion 76 is located at substantially the same radial position as the lip outer surface 47, which is the outer circumferential surface of the outer circumferential lip 34, and thus the inner circumferential edge of the communication passage 74 is located at substantially the same radial position as the lip outer surface 47 of the outer circumferential lip 34.

The communication passages 74 are formed by covering the openings of the grooves 38 formed in the grommet 12 with the bracket 14, and do not require machining that involves making a groove, a hole, or the like in the bracket 14. The grooves 38 open to the surface of the grommet 12 can be formed when the grommet 12 is molded, and thus secondary machining is not required. Thus, the communication passages 74 can be easily formed, and a grommet unit 10 provided with the communication passages 74 can be easily manufactured.

### <Seal Function of Grommet Unit 10>

When water enters the flooding region 82 between the bracket 14 and the panel 52, water is blocked from moving to the inner circumferential side of the grommet 12 by the sealing lip 32. Accordingly, water is prevented from entering the vehicle interior via the electric wire insertion holes 20 of the base portion 16that are located on the inner circumferential side of the sealing lip 32. The sealing lip 32 of the present embodiment has a double-layered seal structure provided with the outer circumferential lip 34 and the inner circumferential lip 36, and thus water can be effectively prevented from moving to the inner circumferential side of the sealing lip 32.

In the present embodiment, on the outer circumferential surface of the base portion 16 overlaid by the bracket 14 and the front surface of the annular mounting portion 30 (first surface 31), a first area that is the area of portions where the grooves 38 are formed and that are not in contact with the bracket 14 is smaller than a second area that is the area of portions where the grooves 38 are not formed and that are in contact with the bracket 14. Accordingly, the force with which the sealing lip 32 is pressed against the panel 52 in the first direction is efficiently transmitted to the grommet 12 from the bracket 14, and a seal realized by the sealing lip 32 between the grommet 12 and the panel 52 can be effectively realized.

If water does enter the flooding region 82 between the outer circumferential end portion of the bracket 14 and the panel 52, the water pressure exerted on the sealing lip 32 is reduced by the communication passages 74. That is, water in the flooding region 82 flows from the first end portion 76 of the communication passages 74 open between the bracket 14 and the panel 52 into the communication passages 74, through the communication passages 74, and is drained to the external space 80 from the second end portion 78 of the communication passages 74. Water in the flooding region 82 surrounded by the bracket 14, the panel 52, and the outer circumferential lip 34 is drained to the external space 80 via the communication passages 74 in communication with the flooding region 82, and thus an increase in the water pressure in the flooding region 82 can be reduced or prevented. Thus, water pressure exerted on the sealing lip 32, which constitutes a part of a wall portion of the flooding region 82, can be suppressed, and a seal realized by the sealing lip 32 can thus be prevented from being broken under high water pressure.

By providing a plurality of communication passages 74, the total cross-sectional area of the communication passages 74 is increased. Thus, water that has entered the flooding region 82 can be swiftly drained via the communication passages 74, and the effect of water pressure exerted on the sealing lip 32 can be effectively suppressed. Water in the flooding region 82 can be swiftly drained through a communication passage 74 near the position where the water entered the flooding region 82, and thus an increase in the water pressure exerted on the sealing lip 32 can be swiftly prevented.

The reinforcing rib 70 of the bracket 14 is provided at a position separated from the fixing portions 66, and thus the reinforcing rib 70 is likely to be weaker than the fixing portions 66 that are pressed against and directly fixed to the panel 52 using bolts. Also, there are cases where the reinforcing rib 70 is slightly distanced from the panel 52 so as to make it easier to fix the fixing portions 66 to the panel 52. Thus, water is likely to enter the flooding region 82 between the reinforcing rib 70 that is distanced from the fixing portions 66 and the panel 52. Therefore, at least one first end portion 76 of a communication passage 74 is located between the fixing portions 66 in the second direction, which is the circumferential direction of the bracket 14, and located near a portion where water is likely to enter the flooding region 82 from the outside. Accordingly, water in the flooding region 82 is swiftly drained through the communication passage 74 near the position where the water entered.

In the communication passage 74, the intermediate portion constituted by the liquid pressure exertion portion 42 of the groove 38 extends in a radial direction between the annular mounting portion 30 of the grommet 12 and the intermediate wall portion 62 of the bracket 14. The pressure of water flowing through a portion including the liquid pressure exertion portion 42 of the communication passage 74 is exerted on the annular mounting portion 30 of the grommet 12, in a direction toward the panel 52. The sealing lip 32 of the annular mounting portion 30 is strongly pressed against the panel 52 by the water pressure exerted on the annular mounting portion 30 in the liquid pressure exertion portion 42. Accordingly, the liquid-tightness realized by the sealing lip 32 is improved between the overlapping surfaces between the annular mounting portion 30 and the panel 52, and the entry of water can be prevented.

In particular, the sealing lip 32 and the liquid pressure exertion portion 42 of the groove 38 are provided so as to be partially located at the same position in a radial direction, and partially overlap each other when seen in a front-rear direction, which is the direction in which the sealing lip 32 is pressed against the panel 52. Thus, water pressure exerted on the annular mounting portion 30 in the liquid pressure exertion portion 42 is directly exerted on the sealing lip 32 in the pressing direction toward the panel 52, and the sealing lip 32 is strongly pressed against the panel 52, and the sealing performance is thus efficiently improved.

The sealing lip 32 is provided on the outer circumferential portion of the annular mounting portion 30 of the grommet 12, and the pressure of water that has entered the flooding region 82 located on the outer circumference of the sealing lip 32 is unlikely to be exerted on the annular mounting portion 30 in the direction opposite the panel 52. Thus, weakening of the pressing of the sealing lip 32 against the panel 52 due to water pressure can be prevented, and sealing performance realized by the sealing lip 32 can be efficiently obtained.

The lip outer surface 47, which is the outer circumferential surface of the outer circumferential lip 34 constituting the sealing lip 32, is located at the same position in the radial direction as the groove bottom surface 46 of the groove 38, and the outer circumferential lip 34 is provided at an outer circumferential end portion of the annular mounting portion 30 of the grommet 12. Thus, water is unlikely to enter between opposing surfaces of the annular mounting portion 30 and the panel 52, and pressing of the sealing lip 32 against the panel 52 can be more effectively prevented from being weakened by water pressure.

At the second end portion 78 of the communication passage 74, the groove 38 constituting a wall surface on the inner circumferential side of the communication passage 74 extends further forward than the second end portion 78. Thus, water that has reached the second end portion 78 via the communication passage 74 is drained toward the outer circumference of the grommet 12 and to the external space 80 from the opening of the groove 38 located forward of the second end portion 78. Accordingly, water drained from the second end portion 78 is unlikely to come into contact with the front surface of the grommet 12 or the electric wires 72.

### Embodiment 2

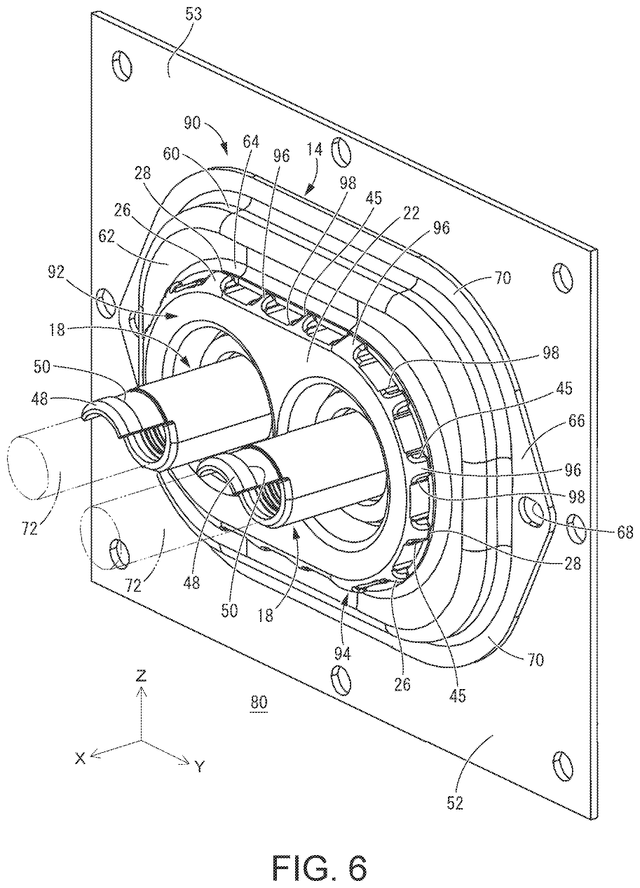

Embodiment 2, which is a separate specific example, is shown in FIGS. 6 to 8. In the following description, members and portions that are substantially identical to those of Embodiment 1 are given the same reference numerals in the drawings, and description thereof is omitted.

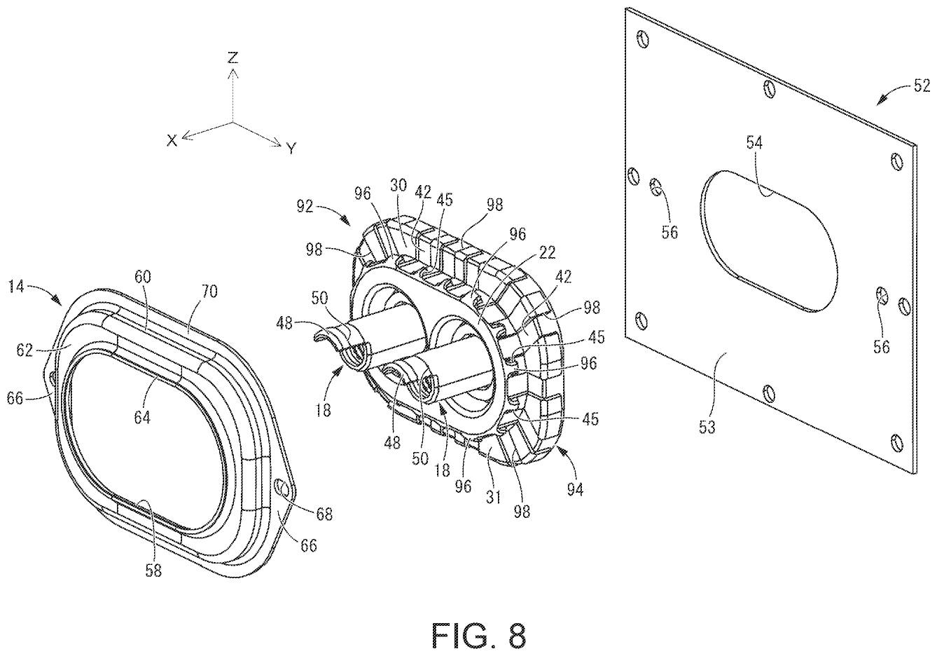

A grommet unit 90 of Embodiment 2 includes a grommet 92 and a bracket 14. As shown in FIG. 8, the grommet 92 includes a base portion 94 and two tubular portions 18. The base portion 94 includes a plurality of locking portions 96 that protrude toward the outer circumference from the protruding portion 22. The locking portions 96 of the present embodiment have a smaller width in the circumferential direction than that of the locking portions 24 in Embodiment 1, and more locking portions 96 are positioned spaced apart from each other in the circumferential direction of the base portion 94 compared to the locking portions 24 of Embodiment 1.

The base portion 94 is provided with a plurality of grooves 98. The grooves 98 are open to the outer circumferential surface of the base portion 94 and the first surface 31, which is the front surface of the annular mounting portion 30, and extend continuously from the rear end to the front end of the base portion 94. The grooves 98 are positioned separated from the locking portions 96 in the circumferential direction of the base portion 94, and are open to groove openings 45 provided between adjacent locking portions 96.

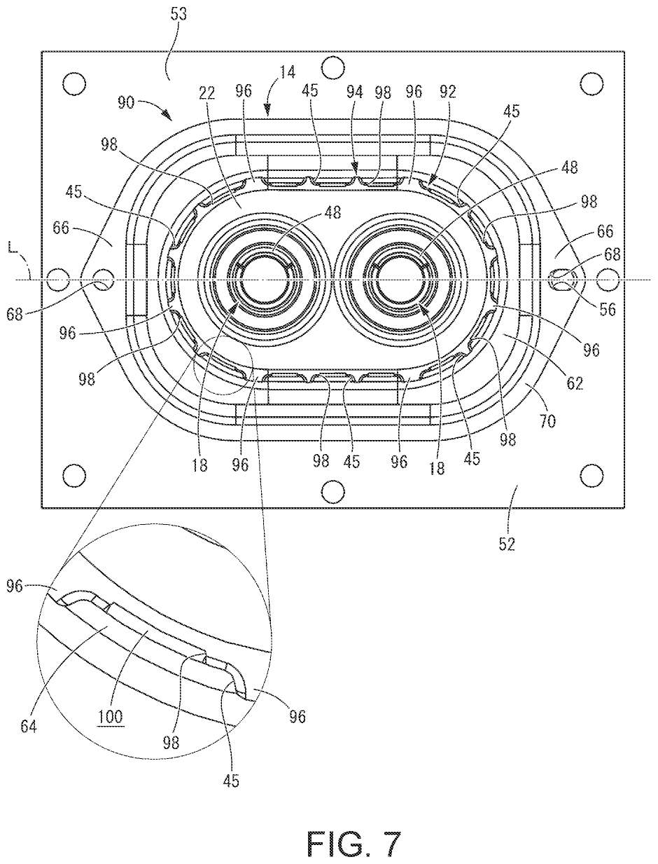

As also shown in FIG. 7, the grooves 98 of the present embodiment have a greater groove width than that of the grooves 38 in Embodiment 1. Also, there are more grooves 98 than there are grooves 38 in Embodiment 1. On the outer circumferential surface of the base portion 94 and the front surface (first surface 31) of the annular mounting portion 30 onto which the bracket 14 is overlaid, a first area that is an area of portions where the grooves 98 are formed and that are not in contact with the bracket 14 is larger than a second area that is an area of portions where the grooves 98 are not formed and that that are in contact with the bracket 14.

Similarly to Embodiment 1, the base portion 94 of the grommet 92 is overlaid onto the vehicle panel 52, and the base portion 94 is attached to the panel 52 using the bracket 14. In the grommet unit 90 in which the bracket 14 is mounted to the grommet 92, the protruding portion 22 of the base portion 94 of the grommet 92 is passed through the insertion hole 58 of the bracket 14 and protrudes forward of the bracket 14, the protruding portion 22 including the locking portions 96. As a result of the surface of the portion of the base portion 94 of the grommet 92 not including the protruding portion 22 being covered by the bracket 14, and the openings of the grooves 98 being covered by the bracket 14, communication passages 100 are formed.

On the surface of the grommet 92 onto which the bracket 14 is overlaid, the first area, which is the area of portions that are not in contact with the bracket 14 due to the grooves 98, is larger than the second area, which is the area of portions that that are in contact with the bracket 14. Accordingly, in the grommet unit 90 of the present embodiment, the total cross-sectional area of communication passages 100 is greater than the total cross-sectional area of the communication passages 74 in Embodiment 1, and the total flow amount of the communication passages 100 is increased. Note that, because the width of each communication passage 100 is increased and there are many communication passages 100, the total flow amount is increased.

Similar to Embodiment 1, with the grommet unit 90, even if water enters between the bracket 14 and the panel 52, an increase in water pressure can be prevented as a result of water being drained via the communication passages 100, and the sealing performance between the grommet 92 and the panel 52 can be secured.

Furthermore, the total flow amount, which is the sum of flow amounts of the communication passages 100, is increased, and thus water that has entered between the bracket 14 and the panel 52 can be efficiently drained via the communication passages 100.

When the pressure of water flowing through the communication passages 100 is exerted on the liquid pressure exertion portion 42 of the groove 98, and the annular mounting portion 30 of the grommet 92 is pressed toward the panel 52 side, the large width of the communication passages 100 and the large area for water pressure exertion achieves a larger force that acts on the annular mounting portion 30. Thus, the sealing performance between the annular mounting portion 30 and the panel 52 can be effectively increased using the pressure of water flowing through the communication passages 100.

### Other Embodiments

The technology described herein is not limited to the embodiments thus described using the above description and drawings, and, for example, the following embodiments are also included in the technical scope of the technology described in the present specification.

(1) In the embodiments, the grommet 12 structured to be provided with two tubular portions 18 for one base portion 16 was given as an example, but only one or three or more tubular portions 18 may be provided for one base portion 16.

(2) The outer circumferential shape of the base portion 16 of the above embodiments was described as having an oval shape including straight portions when seen from the front, but the outer circumferential shape of the base portion is not particularly limited and may have a circular shape when seen from the front, for example. Also, the inner circumferential shape of the bracket may be changed as appropriate to correspond to the outer circumferential shape of the base portion.

(3) The sealing lip 32 provided on the base portion 16 is not limited to a double-layered structure that includes the outer circumferential lip 34 and the inner circumferential lip 36 as indicated in the above embodiments. For example, a sealing lip may be constituted by a single lip, and a sealing lip with a multi-layer structure may also be constituted by three or more lips.

(4) The sealing lip 32 is desirably provided at the outer circumferential portion of the grommet 12, but the sealing lip 32 may be provided on the inner circumferential side of the grommet 12 so as to protrude rearward.

(5) The cross-sectional shape and cross-sectional area of the communication passage 74 may be substantially constant in the longitudinal direction of the passage, and may change stepwise or gradually in the longitudinal direction of the passage.

(6) The number and arrangement of the fixing portions 66 provided in the bracket 14 are not particularly limited, but in order to fix the bracket 14 to the panel 52, it is desirable that a plurality of fixing portions 66 are provided at positions spaced apart from each other in the circumferential direction (second direction) of the bracket 14.

1. A grommet unit to be attached to an attachment surface of an attachment-target body, the grommet unit comprising:
a tubular grommet having a groove on a surface thereof;
a bracket to be overlaid onto the grommet and press the grommet against the attachment-target body in a first direction; and
a communication passage formed by covering the groove of the grommet with the bracket,
wherein the communication passage has a first end that is in communication with a space between overlapping surfaces of the bracket and the attachment surface, and a second end that is in communication with a portion where the grommet and the bracket are not overlaid on each other.

2. The grommet unit according to claim 1,
wherein the groove is provided at a plurality of positions in a circumferential direction of the grommet.

3. The grommet unit according to claim 1, wherein:
the bracket includes an insertion hole into which the grommet is to be inserted, and a fixing portion to be fixed to the attachment-target body,
the fixing portion is provided at a plurality of positions to be spaced apart from each other in a second direction extending in a circumferential direction of the insertion hole, and
the first end of the communication passage is provided between the fixing portions in the second direction.

4. The grommet unit according to claim 1, wherein:
the grommet has a first surface onto which the bracket is to be overlaid in the first direction, and
the groove includes a liquid pressure exertion portion that is adjacent to the first surface.

5. The grommet unit according to claim 4, wherein:
the grommet includes an annular mount to be located between opposing surfaces of the bracket and the attachment-target body,
the annular mount has the first surface, and
the annular mount includes an annular sealing lip that protrudes toward the attachment-target body, on a side opposite to the first surface.

6. The grommet unit according to claim 5,
wherein an outer circumferential surface of the sealing lip is located at a same position as a groove bottom surface of the groove at the first end, in a radial direction of the grommet.

7. The grommet unit according to claim 1,
wherein, a first area that is an area of a portion of the surface of the grommet that is not in contact with the bracket due to the groove being larger than a second area that is an area of a portion of the surface of the grommet that that is in contact with the bracket.

8. The grommet unit according to claim 1, wherein:
the bracket has an annular shape,
the grommet has a protrusion that protrudes further than the bracket in a third direction that is opposite of the first direction, when the grommet is inserted into the bracket,
the groove extends to the protrusion of the grommet,
the grommet includes a lock that locks onto an end surface of the bracket in the third direction, and restricts movement of the grommet in the first direction relative to the bracket, and
the lock is provided at a portion distanced from the groove in the circumferential direction.
